(19) United States
(12) Patent Application Publication
(10) Pub. No.: US 2007/0165134 A1
(43) Pub. Date: Jul. 19, 2007

(54) THREE-DIMENSIONAL IMAGING DEVICE

(75) Inventors: Yoshihiro HAMA, Tokyo (JP); Mikio HORIE, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/623,989

(22) Filed: Jan. 17, 2007

(30) Foreign Application Priority Data
Jan. 18, 2006 (JP) P2006-009500

(51) Int. Cl. G02B 13/16; H04N 5/222

(52) U.S. Cl. 348/370; 348/335

(57) ABSTRACT

A three-dimensional imaging device repeats a process for outputting three-dimensional image signals for displaying first through N-th elemental images that constitute a three-dimensional image. The device includes: an imaging optical system that forms an image of a subject; an illuminating section that repeats an action to irradiate illumination light in several directions in turn to illuminate first through N-th positions on the subject that are different in distance from the imaging optical system; a driving section that repeats an action to drive the imaging optical system so as to focus on one of the first through N-th positions to which the illumination light is irradiated in synchronism with the action of the illuminating section; a capturing section that repeats an action to capture the subject image to generate image signals in synchronism with the action of the illuminating section; and an output section to output the image signal.

### BACKGROUND OF THE INVENTION

The present-invention relates to a three-dimensional imaging device that generates a video signal for displaying a three-dimensional image.

A document 1 represented in a document list described below teaches that there are a head mount method, a glasses method, and a naked eye method as methods to display a three-dimensional image (a moving image). The head mount method uses goggles that contain a pair of small displays for right and left eyes. The head mount method displays images for right and left eyes that have parallax to each other onto the displays for right and left eyes, respectively. The glasses method displays mixed images for right and left eyes that have parallax to each other onto a screen that is viewed by an observer through special glasses. The glasses method includes an anaglyph method that uses color filters, a polarization-glasses method that uses polarizing plates, and a time division method that alternately displays a right image and a left image and alternately opens/closes a pair of liquid crystal shutters that are arranged in front of right and left eyes in synchronism with each other.

The naked eye method does require neither the special goggles nor special glasses. A document 2 teaches that the naked eye method includes a two eyes method, a multi-eye method, a super multi-eye method, a stereoscopic illusion method, and a volume method.

The two eyes method displays a normal image on a single screen that is covered with a filter to generate parallax between right and left. The two eyes method further includes principally a parallax barrier method and a lenticular method. In the parallax barrier method, a screen is covered with a filter on which a plurality of parallel slits are formed in a vertical direction. In the lenticular method, a screen is covered with a lenticular sheet on which a plurality of parallel cylindrical lenses are arranged in a vertical direction.

The multi-eye method displays a normal image on a screen that generates parallax corresponding to a position of a view point that can be located at any position in a space. The multi-eye method principally includes an integral method and a step barrier method, In the integral method, a screen is covered with a filter like a compound-eye lens. In the step barrier method, a screen is covered by a filter on which infinite number of microscopic holes are formed.

The super multi-eye method directly projects a plurality of images that are obtained by taking an object from a plurality of view points into right and left eyes so that two or more images are viewed by each of right and left eyes. According to the super multi-eye method, an. observer recognizes that images with parallax are overlapped when he or she focuses on the convergence point (when he or she resolves the contradiction between convergence and accommodation that causes visual fatigue). The super multi-eye method principally includes a focused light array (FLA) method and a fan-like array of projection optics (FAPO) method.

The stereoscopic illusion method superimposes two images, which are obtained by taking from two view points that are different in the taking direction, onto a screen by means of a half mirror, and changes the luminance value of the front image with respect to the luminance value of the rear image. The stereoscopic illusion method gives an observer the optical illusion that the superimposed image has a depth.

The volume method scans an object three-dimensionally in advance and reproduces (displays) a three dimensional image in a space by distributing image points in the space by a three-dimensional scan mechanism. Documents 2 through 4 teach that the volume method principally includes: a half-mirror multilayer composite method (a document 5), a perspective screen multilayer composite method (documents 6 and 7), a liquid crystal screen method, a varifocal mirror method, a varifocal lens method (documents 8 and 9), a plane screen moving method (a document 10), and a plane screen rotation method (documents 11 through 14).

Document List

Document 1: Takashi Kawai, “Recommendation of Stereoscopic Media Creation Chapter 3 Stereo Display”, 3D consortium operation secretariat, downloaded from http://www.creatorslounge.com/seminar/003_{—}3.html on Sep. 14, 2005.

Document 2: “Surveillance Study Report about Stereoscopic Image Display in Heisei 16 fiscal year”, Japan Machinery Federation, Japan Optoelectro Mechanics Association, pages 18 through 72, downloaded from http://www.joem.or.jp/h16_rittaieizou.pdf on Sep. 14, 2005.

Document 3: “Foundation of Three-dimensional Image Display”, Yoshikawa laboratory in Department of Electronics and Computer Science in Nihon Unifersith College of Science and Technology, downloaded from http://www.ecs.cst.nihon-u.ac.jp/oyl/3d/index.html on Sep. 14, 2005.

Document 4: Hiroshi Inoue, “Explore Wonder of Stereoscopic Vision”, Optronics (1999), ISBN:4900474746.

Document 5: JP09-091468A

Document 6: JP2001-054144A

Document 7: JP2000-115812A (Patent 3081589)

Document 8: JP2002-10298A (Patent 3479631)

Document 9: JP2000-338900A

Document 10: JP06-006830A

Document 11: JP2001-352565A

Document 12: JP2001-346227A

Document 13: JP2000-278711A

Document 14: JP06-274106A

In the field of brain surgery, a system that displays stereoscopic image that is acquired by enlarging radiography through the use of a stereoscopic microscope is developed. This system can not only provide an enlarged stereoscopic image to doctors who directly perform surgery on a patient, but also provide an enlarged stereoscopic image to assistants who support the surgery, persons who instruct the surgery from remote place, interns and students who study surgical technique.

The conventional method such as the head mount method, the glasses method, the two eyes method and the multi-eye method displays an enlarged stereoscopic image of a surgery region through the use of parallax. According to the display methods using parallax, although a person who views an image recognizes that a stereoscopic object locates at a convergent position that is different from a screen on which the image is displayed, eyes of the person focus on the screen. This cannot give a depth feeling or may cause a reversal phenomenon of a depth feeling, that is, a distant object seems near. Therefore, the conventional method that displays an enlarged stereoscopic image using parallax is difficult to be used in the field of brain surgery that requires a clear depth feeling to see a movement of a treatment tool.

On the other hand, we have developed a three-dimensional display device that adopts a volume method to reproduce a three-dimensional image stereoscopically rather than adapting the display method using parallax that causes the above mentioned problems. We have filed the patent applications about the device with the Japanese Patent Office. The application numbers of these applications are 2004-339870 and 2004-339871. These applications are not prior art because they were published after the priority date of the present application. The three-dimensional display device reproduces a three-dimensional image in a space using persistence of vision. That is, the device has a projecting optical system and a plurality of screens that are selectably appeared in to the projection space in turn. The screens can be appeared at the positions that are different in distance from the projection optical system. The device brings the screens into the projection space during short period in turn, and projects an image onto the inserted screen to be focused thereon. Conventionally, there was no imaging device that can supply an image signal to the three-dimensional display device that adapts the volume method in the field of brain surgery.

### SUMMARY OF THE INVENTION

The present invention is accomplished to solve the above-mentioned problem in the prior art, and an object thereof is to provide an improved three-dimensional imaging device that is capable of supplying a image signal to a three-dimensional display device that brings the screens in turn at positions that are different in distance from a projecting optical system.

A three-dimensional imaging device of the present invention, which is developed to achieve the above-mentioned object, repeats a process for outputting three-dimensional image signals for displaying first through N-th elemental images that constitute a three-dimensional image. The three-dimensional imaging device includes: an imaging optical system that forms an image of a subject with a focusing function and a compensation function to keep image magnification constant; an illuminating section that repeats an action to irradiate illumination light in several directions that cross in its optical axis direction in turn to illuminate first through N-th positions on the subject that are different in distance from the imaging optical system; a driving section that repeats an action to drive the imaging optical system so as to focus on one of the first through N-th positions to which the illumination light is irradiated by the illuminating section in synchronism with the action of the illuminating section; a capturing section that repeats an action to capture the subject image formed by the imaging optical system to generate image signals in synchronism with the action of the illuminating section; a superimposition section that superimposes a depth synchronizing signal on the image signal generated by the capturing section, as a synchronizing signal to specify which of the first through N-th elemental images is represented by the image signal, and an output section to output the superimposed image signal.

With this configuration, the superimposed image signal can be used in a three-dimensional display device that brings the screens in turn at positions that are different in distance from a projecting optical system in the projecting direction. That is, receiving the superimposed image signal, the three-dimensional display device divides the frames that constitute the image signals into groups one of which includes first through N-th elemental images that constitute one three-dimensional image based on the depth synchronizing signals superimposed on the image signals. And then, the three-dimensional display device projects the elemental images onto screens at first through N-th positions, respectively, so that each elemental image is focused on the corresponding screen.

In the three-dimensional imaging device of the present invention, the depth synchronizing signal is not always superimposed on the image signal. When the depth synchronizing signal is not superimposed on the image signal, the three-dimensional display device that receives the image signal from the three-dimensional imaging device should have a function to divide the frames that constitute the image signals into groups one of which includes first through N-th elemental images (a function to automatically divide the frames into groups each of which includes N pieces of frames, for example).

According to the present invention, the image signals can be supplied to the three-dimensional display device that brings the screens in turn at positions that are different in distance from a projecting optical system in the projecting direction.

### DESCRIPTION OF THE ACCOMPANYING DRAWINGS

FIG. 1 is a block diagram of a three-dimensional imaging system concerning a first embodiment of the present invention,

FIG. 2 shows optical and mechanical configurations of a camera unit included in the system shown in FIG. 1,

FIG. 3 is a block diagram of a main unit included in the system shown in FIG. 1,

FIG. 4 is a perspective view showing an optical configuration of a collimating optical system included in an illumination unit of the system shown in FIG. 1,

FIG. 5 shows an optical configuration of a collimating optical system included in a three-dimensional imaging system concerning a second embodiment of the present invention, FIG. 6 shows an optical configuration of a collimating optical system included in a three-dimensional imaging system concerning a third embodiment of the present invention,

FIG. 7 shows a configuration of one of four illumination units included in a three-dimensional imaging system concerning a fourth embodiment of the present invention, and

FIG. 8 shows a configuration of a driving mechanism for a camera unit included in a three-dimensional imaging system concerning a fifth embodiment of the present invention.

### DESCRIPTION OF THE PREFERRED EMBODIMENTS

Hereafter, five embodiments of the present invention will be described in detail with reference to the attached drawings.

### First Embodiment

First, a configuration of a three-dimensional imaging system of the first embodiment will be described.

The three-dimensional imaging system of the first embodiment takes an enlarged image of an operating section in brain surgery, for example, to generate image signals that are supplied to a predetermined three-dimensional display device that reproduces a three-dimensional image stereoscopically.

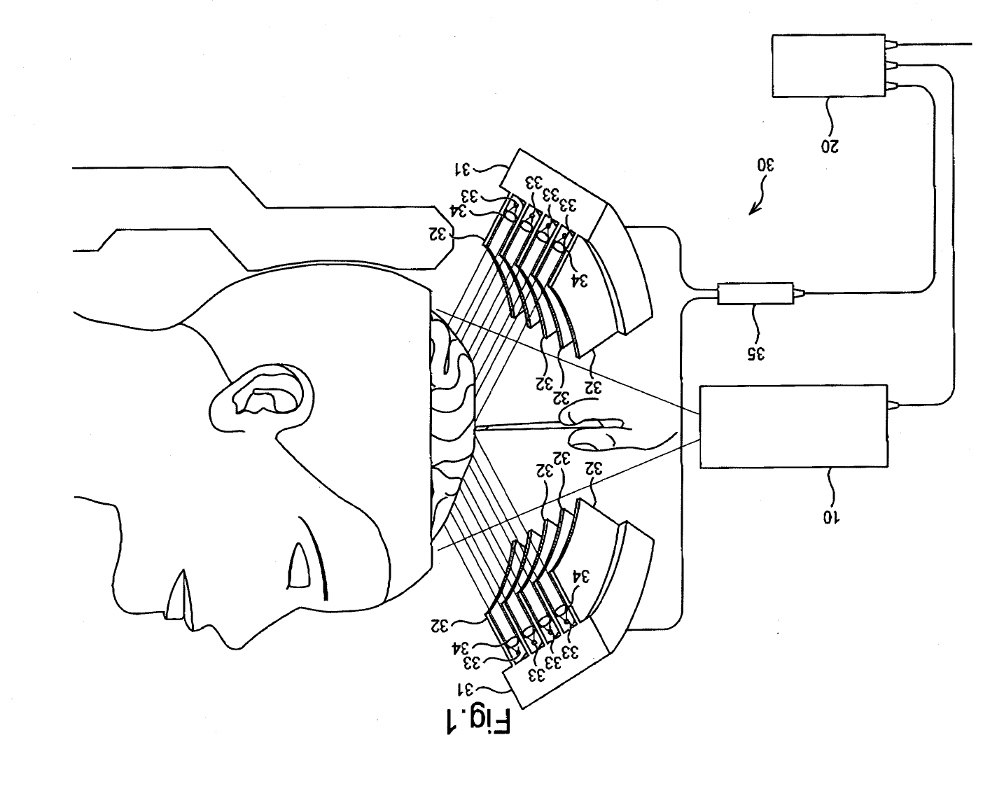

FIG. 1 is a block diagram of a three-dimensional imaging system concerning the first embodiment.

As shown in FIG. 1, the three-dimensional imaging system of the first embodiment consists of a camera unit 10, a main unit 20, and illumination unit 30.

The camera unit 10 takes an image of a subject in afield of view. The main unit 20 processes signals generated by the camera unit 10 to output the above-mentioned image signal. The illumination unit 30 irradiates a subject with illumination light required for the image taking by the camera unit 10.

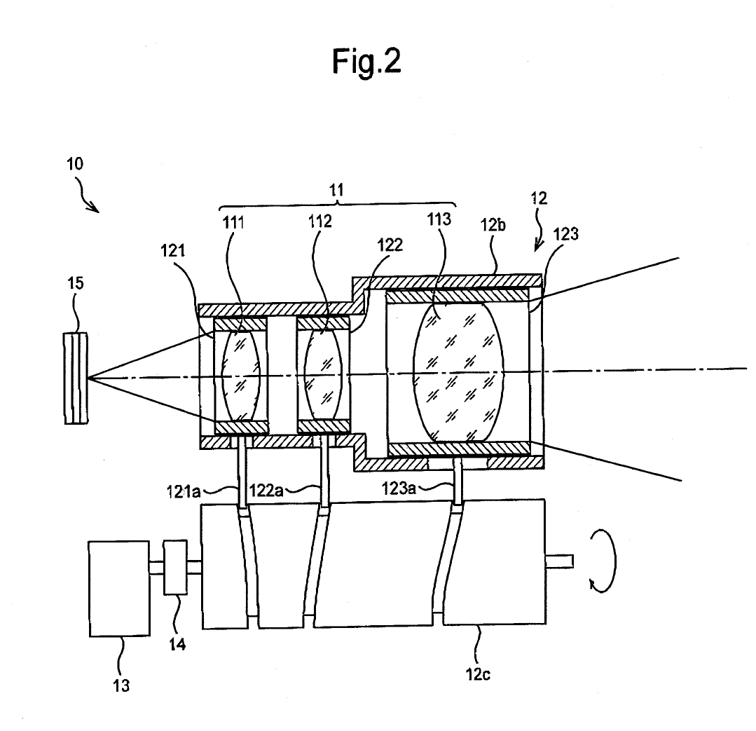

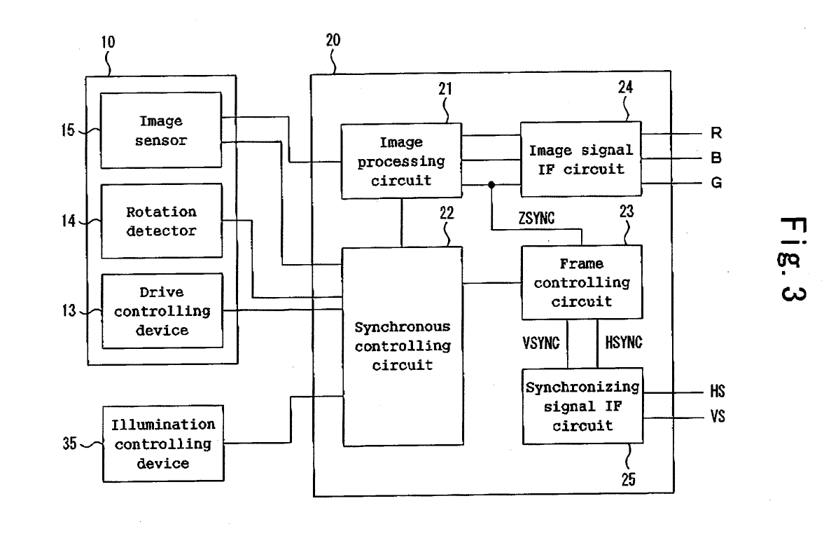

FIG. 2 shows a configuration of the camera unit 10.

The camera unit 10 includes an imaging optical system 11, a driving mechanism 12, a drive controlling device 13, a rotation detector 14, and an image sensor 15.

The imaging optical system 11 consists of a first lens 111, a second lens 112, and a third lens 113. The driving mechanism 12 consists of a first lens frame 121, a second lens frame 122, a third lens frame 123, a lens-barrel 12b, and a cylindrical grooved cam 12c.

The first, second, and third lenses 111, 112, and 113 are supported by the first, second, and third lens frames 121, 122, and 123, respectively. These lens frames 121, 122, and 123 are fitted into the lens-barrel 12b so that they can slide in an axial direction only. Three slits parallel to the axial direction are formed on the lens-barrel 12b so as to align on a straight line. Pin-shaped cam followers 121a, 122a, and 123a extended from the first, second, and third lens frames 121, 122, and 123 come through the slits, respectively. A tip portion of each of the cam followers 121a, 122a, and 123a juts out of the lens-barrel 12b through the slit and is inserted into each of cam grooves formed around the cylindrical grooved cam 12c. The cylindrical grooved cam 12c is rotatably mounted in the camera unit 10 so as to be parallel to the lens-barrel 12b. When the cylindrical grooved cam 12c rotates, the cam followers 121a, 122a, and 123a move in parallel in the axial direction with movement of the intersections of the cam grooves and the slits, which moves the first, second, and third lens 111, 112, and 113 in the axial direction together with the corresponding cam followers 121a, 122a, and 123a.

In the first embodiment, the shapes of the cam grooves on the cylindrical grooved cam 12c, the positions and lengths of the slits of the lens-barrel 12b, and the specifications (focusing, compensation, etc.) of the imaging optical system 11 are defined so as to keep the image magnification constant regardless of the change of focus.

The drive controlling device 13 contains a motor (not shown) to rotate the cylindrical grooved cam 12c and some gears (not shown) to transmit the rotating power of the motor to the cylindrical grooved cam 12c. The drive controlling device 13 controls rotating speed and rotating direction of the cylindrical grooved cam 12c by controlling quantity and polarity of electric power supplied to the built-in motor (not shown). The drive controlling device 13 is connected to the main unit 20. The drive controlling device 13 changes the rotating speed and the rotating direction of the cylindrical grooved cam 12c at a timing of a switching signal (described below) from the main unit 20. Specifically, the drive controlling device 13 changes the rotating speed and the rotating direction of the cylindrical grooved cam 12c according to the above-mentioned timing so that the imaging optical system 11 repeatedly focuses on a plurality of positions that are different in the optical axis direction in turn. In addition, in the first embodiment, the imaging optical system 11 focuses on first through fourth focus positions that are established at equal intervals from the near side to the far side of the imaging optical system 11.

The rotation detector 14 is a sensor such as a resolver, an incremental rotary encoder, and an absolute rotary encoder for detecting the rotating speed and the rotating direction of the cylindrical grooved cam 12c. The rotation detector 14 is connected to the main unit 20. The detection signal is outputted to the main unit 20. The detection signal is used for a feedback control of the rotating amount of the cylindrical grooved cam 12c that is driven by the drive controlling device 13 and for detection of the rotating direction thereof.

The image sensor 15 is a single-plate area image sensor having an imaging surface that consists of a large number of pixels arranged in two dimensions. The imaging surface is covered by a color filter of the complementary color system. The imaging surface of the image sensor is arranged at the image surface position of the imaging optical system 11, and a subject image formed on the imaging surface by the imaging optical system 11 is converted into complementary color signals by the image sensor 15. The image sensor 15 is connected to the main unit 20. The image sensor 15 performs an electric charge flushing process and a complementary color signal output process at the timing designated by a drive signal (described below) from the main unit 20.

FIG. 3 is a block diagram of the main unit 20.

The main unit 20 includes an image processing circuit 21, a synchronous controlling circuit 22, a frame controlling circuit 23, an image signal IF circuit 24, and a synchronizing signal IF circuit 25.

The image processing circuit 21 generates an RGB image signal by performing a matrix process etc. to the complementary color signal outputted from the image sensor 15

The synchronous controlling circuit 22 generates various kinds of synchronizing signals based on a reference signal outputted from a timing generator (not shown). The synchronous controlling circuit 22 outputs a vertical synchronizing signal (VSYNC) and a horizontal synchronizing signal (HSYNC) that are used in the image signal to the image processing circuit 21. Further, the synchronous controlling circuit 22 outputs a drive signal that periodically defines the electric charge storage period and electric charge flushing period to the image sensor 15. Still further, the synchronous controlling circuit 22 outputs a switching signal, which is equivalent to the drive signal to the image sensor 15, to the drive controlling device 13. In the drive controlling device 13, when the drive signal defines the electric charge storage period (when the signal level is low or high, or during a period between pulses), the switching signal defines a static period for the respective lenses 111, 112, and 113. When the drive signal defines the electric charge flushing period, the switching signal defines a moving period for the respective lenses 111, 112, and 113.

The frame controlling circuit 23 generates the depth synchronizing signal (ZSYNC) based on the vertical synchronizing signal and the horizontal synchronizing signal that are outputted from the synchronous controlling circuit 22. The depth synchronizing signal is used for dividing the image signals from the image processing circuit 21 into groups each of which includes a predetermined number of frames (four frames in this embodiment). The depth synchronizing signal is superimposed on the G signal among the RGB image signals outputted from the image processing circuit 21.

The image signal IF circuit 24 outputs the R signal and the B signal that are outputted from the image processing circuit 21, and outputs the G signal on which the depth synchronizing signal is superimposed. These signals are outputted to the above-mentioned three-dimensional display device through external terminals.

The synchronizing signal IF circuit 25 outputs the vertical synchronizing signal and the horizontal synchronizing signal, which are outputted from the frame controlling circuit 23, to the above-mentioned three dimensional display device through the external terminals.

The illumination unit 30 includes a truncated cone pipe block 31, a flange-shaped screen 32, a linear light source 33, a collimating optical system 34, and an illumination control device 35, as shown in FIG. 1.

The truncated cone pipe block 31 is the short truncated cone pipe block whose axial length is relatively shorter than its radial length. The five flange-shaped screens 32 are formed inside the truncated cone pipe block 31. The flange-shaped screens 32 stand perpendicularly to the inner surface of the truncated cone pipe block 31 and have the same height with respect to the inner surface. In FIG. 1, the truncated cone pipe block 31 and the flange-shaped screens 32 are formed as sectors whose central angles are 60 degrees. Three sets of the truncated cone pipe block 31 and the flange-shaped screens 32 are arranged in equal angular pitches. However, one set is not shown in FIG. 1 because it is arranged in a space over the paper. These truncated cone pipe block 31 and flange-shaped screen 32 may be formed around the perimeter about the axis, or may be formed as three or more separate sets as shown in FIG. 1. In the latter case, although the illumination capacity declines, an access to an operating section becomes easy.

The five flange-shaped screens 32 are arranged at equal intervals in the generatrix direction of the truncated cone pipe block 31. The linear light source 33 is located in each of four spaces between a pair of the flange-shaped screens 32. The linear light source 33 is formed as a line that is twisted with respect to the optical axis of the imaging optical system 11. The linear light source 33 is attached to tho truncated cone pipe block 31 at the position close to the inner surface in the above-mentioned space along the circumferential direction of the truncated cone pipe block 31. The linear light source 33 is a point light source in the section perpendicular to the circumferential direction. When being energized, the linear light source 33 emits illumination light to all directions from the point light source.

Each of the above-mentioned four spaces is provided with the collimating optical system 34 at the side of the center axis than the linear light source 33. The collimating optical system 34 converts the divergent illumination light from the linear light source 33 into a parallel beam in the section perpendicular to the center axis.

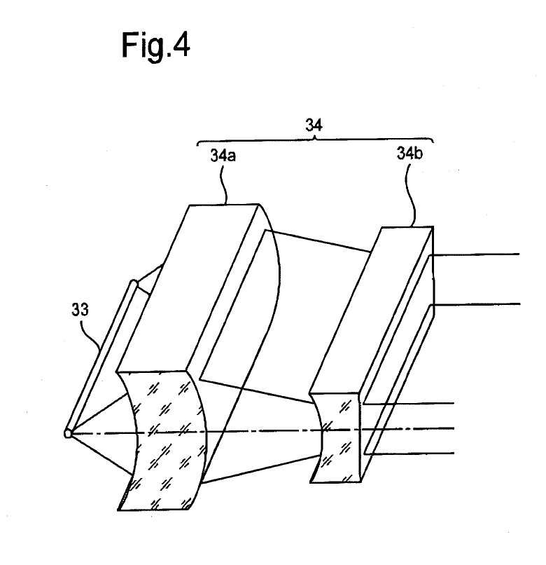

FIG. 4 is a perspective view showing the specific optical configuration of the collimating optical system 34. Although the linear light source 33 and the collimating optical system 34 are curved along the circumferential direction of the truncated cone pipe block 31 in fact, they are developed into straight shapes in FIG. 4.

As shown in FIG. 4, the collimating optical system 34 consists of first and second anamorphic lenses 34a and 34b. The first anamorphic lens 34a has no power in the section perpendicular to the generatrix of the truncated cone pipe block 31 (i.e., the section parallel to both of the right-left direction and the front-rear direction in FIG. 4), and has a positive power in total by the positive meniscus shape in the section perpendicular to the circumferential direction (i.e., the section perpendicular to the linear light source 33). The first anamorphic lens 34a converts the divergent illumination light into the convergent light in the section perpendicular to the circumferential direction. The second anamorphic lens 34b has no power in the section perpendicular to the generatrix of the truncated cone pipe block 31, and its front surface has a negative power in the section perpendicular to the circumferential direction of the truncated cone pipe block 31. The second anamorphic lens 34b converts the convergent illumination light from the first anamorphic lens 34a into the parallel beam in the section perpendicular to the circumferential direction.

Since each of the above-mentioned four spaces includes the linear light source 33 and the collimating optical system 34 as shown in FIG. 4, the divergent illumination light emitted from the linear light source 33 is converted into the parallel beam that is parallel to the flange-shaped screens 32 in the section perpendicular to the circumferential direction of the truncated cone pipe block 31 in any spaces. Then, the illumination light passes through the space between the flange-shaped screens 32 and is directed to the center axis of the truncated cone pipe block 31. Accordingly, if the truncated cone pipe block 31 and the flange-shaped screen 32 are formed around the perimeter about the axis, the illumination lights from all the radial directions are converged to the center axis. When the truncated cone pipe block 31 and the flange-shaped screen 32 are separated into several portions as shown in FIG. 1, the illumination lights from the portions in the radial directions are converged to the center axis. In latter case, when the linear light sources 33 are numbered from left to right in FIG. 1, that is, assuming that the first to fourth linear light sources are arranged from left to right in FIG. 1, the illumination lights from the linear light sources of the same number in the different portions are converged in the same position. At this time, the converged positions of the illumination lights from the linear light sources 33 align at equal intervals in the same order of the alignment of the linear light sources 33 in the center axis direction of the truncated cone pipe block 31.

Here, the truncated cone pipe block 31 to which the linear light sources 33 and the collimating optical systems 34 are attached is supported at a tip of an arm (not shown) The truncated cone pipe block 31 is installed near an operating section of a patient so that its center axis is coincident with the optical axis of the imaging optical system 11 in the camera unit 10. At this time, the position of the camera unit 10 and the position of the truncated cone pipe block 31 are adjusted so that the above-mentioned first through fourth focus positions are coincident with the convergent positions of the illumination lights from the first through fourth linear light sources 33, respectively.

The illumination controlling device 35 controls lighting of the first through fourth linear light sources 33 attached in the above-mentioned four spaces, respectively. The illumination controlling device 35 receives the switching signal equivalent to the vertical synchronizing signal from the synchronous controlling circuit 22 of the main unit 20. The illumination controlling device 35 supplies an electric current to the linear light sources 33 one by one in synchronization with the timing of the frame change in the image signal to repeatedly light the four linear light sources 33 in order. Therefore, the illumination light is incident on each of the first through fourth focus points one by one in order by means of the illumination controlling device 35.

Next, operations and effects of the three-dimensional imaging system of the first embodiment will be described.

A user sets up the camera unit 10 and the truncated cone pipe block 31 of the three-dimensional imaging system so that the first through fourth focus positions are coincident with the operating section. Subsequently, the user connects the above-mentioned three-dimensional display device (not shown) to the main unit 20 so that the RGB image signals, the vertical synchronizing signal, and the horizontal synchronizing signal can be outputted to the three-dimensional display device, Then, the user switches on the main power supply and starts to capture images.

Then, each of the four linear light sources 33 aligned in the generatrix direction emits the illumination light one by one in order, the cylindrical grooved cam 12c rotates by every 90 degrees in synchronization with the emissions of the light sources. And also, the image sensor 15 repeats the flushing process to flush stored charge in synchronization with the emissions of the light sources. The parts in the first through fourth focus positions in the operating section are illuminated one by one in order. A shape of an illuminated part is a round slice. The camera unit 10 focuses on the illuminated part among the first through fourth focus positions and captures an image of the illuminated part.

Here, if viewed in the section perpendicular to the circumferential direction of the truncated cone pipe block 31, the incidence direction of the illumination light is inclined with respect to the direction perpendicular to the optical axis of the imaging optical system 11. Although this inclination is emphasized in FIG. 1, the inclination is only a few degrees in fact. The illumination light should be inherently incident on the operating section in the direction perpendicular to the optical axis of the imaging optical system 11. However, such an arrangement may generate an area that cannot be illuminated due to various obstacles. Therefore, the direction of the illumination light is slightly inclined with respect to the direction perpendicular to the optical axis.

The image signals are acquired by repeating the sampling in the depth direction (i.e., the direction of the optical axis of the imaging optical system). The-image signals are outputted as groups each of which includes four frames representing the first through fourth focus positions that are captured when the imaging optical system 11 focus on the first through fourth focus positions, respectively. The depth synchronizing signal (ZSYNC) is superimposed on the G signal in each frame. When the image signals are outputted to the above-mentioned three-dimensional display device (not shown), the three-dimensional display device acquires the frames as groups each of which includes four frames. The three-dimensional display device reproduces a three-dimensional image every time one group is received.

The detail configuration of the three-dimensional display device is described in Japanese patent applications 2004-339870 and 2004-339871. In brief, the three-dimensional display device reproduces a three-dimensional image in a space using persistence of vision. That is, the device has a projecting optical system and a plurality of screens (four screens are suitable in the first embodiment) that are selectably appeared in the projection space in turn. The screens can be appeared at the positions that are different in distance from the projection optical system. The device brings the screens into the projection space during short period in turn, and projects an image onto the inserted screen to be focused thereon.

The three-dimensional display device (not shown) extracts the depth synchronizing signal from G signal, when the RGB image signals are inputted from the main unit 20. On the basis of the vertical synchronizing signal inputted with a different channel and the extracted depth synchronizing signal, the three-dimensional display device (not shown) controls the appearance timing of the four screens into the optical path and controls the projecting optical system so as to focus on a screen appeared in the optical path.

As a result of such a control, the three-dimensional display device projects images of four frames with time difference onto the four screens that are different in depth, respectively. The images projected on the four screens give a user the optical illusion that the four images form one three-dimensional image. When three-dimensional display device repeatedly reproduces images using the four screens, the user recognizes that the three-dimensional image moves.

Thus, the three-dimensional imaging system of the first embodiment can supply the image signals that can be processed by the above-mentioned three-dimensional display device.

### Second Embodiment

In the second embodiment, the configuration of the collimating optical system in the illumination unit is different from that in the first embodiment. A reflecting mirror is added at the opposite side of the first anamorphic lens with respect to the linear light source 33. The other configurations are identical to the first embodiment.

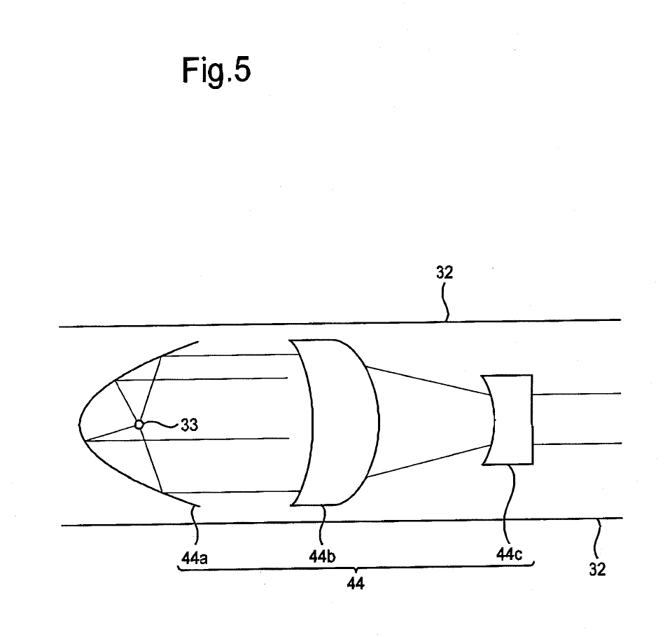

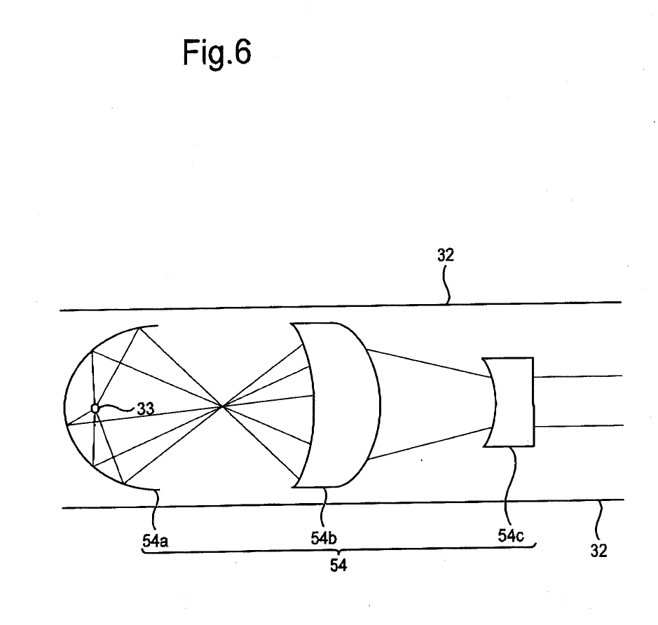

FIG. 5 shows an optical configuration of the collimating optical system 44 of the second embodiment.

As shown in FIG. 5, the collimating optical system 44 of the second embodiment consists of a reflecting mirror 44a, a first anamorphic lens 44b and a second anamorphic lens 44c.

The reflecting mirror 44a has an anamorphic reflecting surface whose shape in the section perpendicular to the circumferential direction of the linear light source 33 (i.e., the section parallel to the sheet of FIG. 5) is a parabola. The reflecting mirror 44a is mounted between the flange-shaped screens 32 so that the focus of the parabola is coincident with the position of the linear light source 33 in the first embodiment. Therefore, in the above-mentioned section, the illumination light reflected by the reflecting mirror 44a is converted into the parallel beam that is parallel to the flange-shaped screen 32.

The first anamorphic lens 44b has no power in the section perpendicular to the generatrix (i.e. the section perpendicular to the up-down direction of the sheet of FIG. 5), and has a positive power in total by the positive meniscus shape in the section perpendicular to the circumferential direction (i.e., the section parallel to the sheet of FIG. 5). The first anamorphic lens 44b converts the parallel beam reflected from the reflecting mirror 44a into the convergent light in the section perpendicular to the circumferential direction. The second anamorphic lens 44c has no power in the section perpendicular to the generatrix, and its front surface has a negative power in the section perpendicular to the circumferential direction. The second anamorphic lens 44c converts the convergent illumination light from the first anamorphic lens 44b into the parallel beam in the section perpendicular to the circumferential direction.

That is, the first and second anamorphic lenses 44b and 44c constitute an afocal optical system in the section perpendicular to the circumferential direction.

With this configuration, much of the illumination light directed to other than the first anamorphic lens 44b is reflected by the reflecting mirror 44a and is guided to the first anamorphic lens 44b. Therefore, if the same linear light source 33 is used, the illumination light in the second embodiment is brighter than that in the first embodiment.

### Third Embodiment

In the third embodiment, the configuration of the collimating optical system in the illumination unit is different from that in the first embodiment. A reflecting mirror is added at the opposite side of the first anamorphic lens with respect to the linear light source 33 in the same manner as the second embodiment. However, in the third embodiment, the shape of the reflecting mirror in the section perpendicular to the circumferential direction is ellipse that is different from a parabola in the second embodiment. The other configurations are identical to the first embodiment.

FIG. 6 shows an optical configuration of the collimating optical system 54 of the third embodiment. As shown in FIG. 6, the collimating optical system 54 of the third embodiment consists of a reflecting mirror 54a, a first anamorphic lens 54b and a second anamorphic lens 54c. The reflecting mirror 54a has an anamorphic reflecting surface whose shape in the section perpendicular to the circumferential direction of the linear light source 33 (i.e., the section parallel to the sheet of FIG. 6) is an ellipse, The reflecting mirror 54a is mounted between the flange-shaped screens 32 so that one focal point that is distant from the reflecting surface among two focal points of the ellipse is coincident with the position of the linear light source 33 in the first embodiment,

Therefore, in the above-mentioned section, the diverged illumination light emitted from the linear light source 33 and reflected by the reflecting mirror 54a is once converged at the distant focal point and is diverged. The first anamorphic lens 54b has no power in the section perpendicular to the generatrix (i.e., the section perpendicular to the up-down direction of the sheet of FIG. 6), and has a positive power in total by the positive meniscus shape in the section perpendicular to the circumferential direction (i.e., the section parallel to the sheet of FIG. 6) The first anamorphic lens 54b converts the divergent beam reflected from the reflecting mirror 54a into the convergent light in the section perpendicular to the circumferential direction. The second anamorphic lens 54c has no power in the section perpendicular to the generatrix, and its front surface has a negative power in the section perpendicular to the circumferential direction. The second anamorphic lens 54c converts the convergent illumination light from the first anamorphic lens 54b into the parallel beam in the section perpendicular to the circumferential direction. With this configuration, much of the illumination light directed to other than the first anamorphic lens 54b is reflected by the reflecting mirror 54a and is guided to the first anamorphic lens 54b. Therefore, if the same linear light source 33 is used, the illumination light in the third embodiment is brighter than that in the first embodiment.

### Fourth Embodiment

In the fourth embodiment, the configuration of the illumination unit is different from that in the first embodiment. The illumination unit in the first embodiment has a plurality of linear light sources 33 that turn on one by one in order. On the other hand, the illumination unit in the fourth embodiment has a single linear light source 33 and deflects the illumination light from the linear light source 33 by a galvanometer mirror so that the illumination light is guided to the first through fourth focus positions in order. Since the galvanometer mirror cannot be constituted as a curved surface, an illumination unit 60 contains a straight linear light source and galvanometer mirror, and four illumination units 60 are arranged around the operating section to illuminate the operating section in four directions that are perpendicular to the optical axis of the imaging optical system 11.

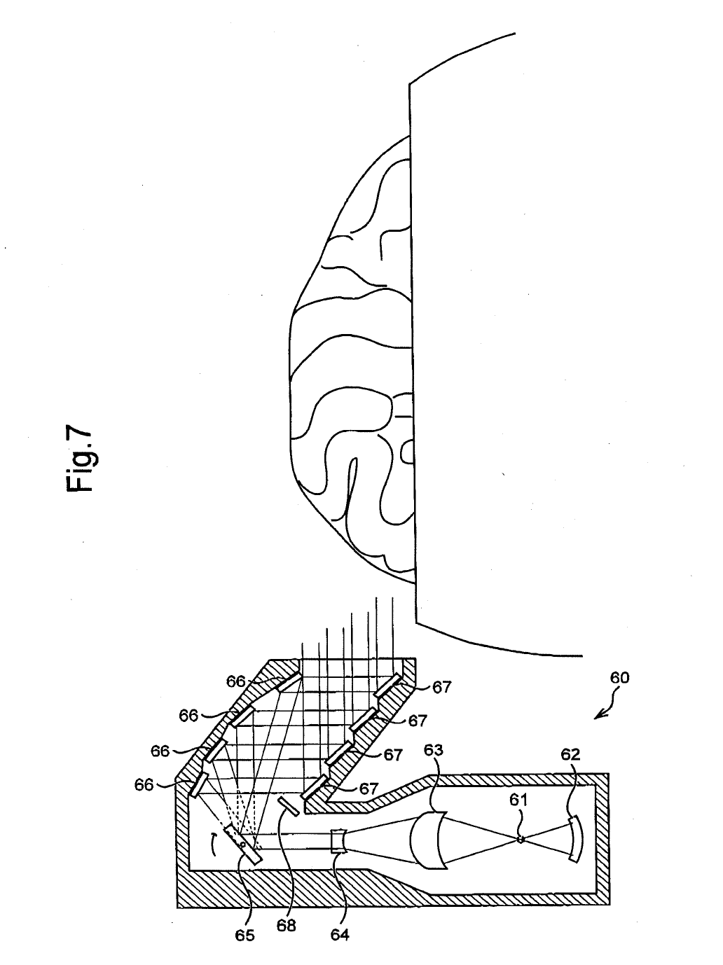

FIG. 7 shows a configuration of one of the four illumination units 60 of the fourth embodiment.

The illumination unit 60 of the fourth embodiment is provided with a linear light source 61, a reflecting mirror 62, a long length lens 63, a cylindrical lens 64, a galvanometer mirror 65, four first mirrors 66, four second mirrors 67, and a mirror position detector 68.

The linear light source 61 is formed in a straight shape as mentioned above and it is a point light source in the section perpendicular to the linear direction (i.e., a section parallel to the sheet in FIG. 7). The reflecting mirror 62 has a cylindrical reflecting surface whose section is an arc. The reflecting mirror 62 is mounted on the case of the illumination unit 60 so that the center of a circle including the arc is coincident with the linear light source 61. In the section perpendicular to the linear light source 61, the illumination light that is emitted from the linear light source 61 and is reflected by the reflecting mirror 62 once converges at the position of the linear light source 61, and then diverges toward the opposite side of the reflecting mirror 62 in the same manner as the illumination light diverging from the linear light source 61.

The long length lens 63 is arranged at the side opposite to the reflecting mirror 62 with respect to the linear light source 61. The long length lens 63 has no power in the section including the linear light source 61 (i.e., the section perpendicular to the sheet of FIG. 7) and has a positive power in total by the positive meniscus shape in the section perpendicular to the linear light source 61 (i.e., the section parallel to the sheet of FIG. 7). The long length lens 63 converts the divergent illumination light into the convergent light in the section perpendicular to the linear light source 61.

The cylindrical lens 64 has no power in the section including the linear light source 61 and its front surface has a negative power in the section perpendicular to the linear light source 61. The cylindrical lens 64 converts the convergent illumination light from the long length lens 63 into the parallel beam in the section perpendicular to the linear light source 61.

The galvanometer mirror 65 is a rectangular mirror that is rotatably supported by a rotating shaft inside the case of the illumination unit 60. The rotating shaft is coincident with the center axis in the longitudinal direction of the galvanometer mirror 65 and is parallel to the linear light source 61. The galvanometer mirror 65 is arranged in the optical path of the illumination light that is parallel beam converted by the cylindrical lens 64. The illumination light is deflected by the galvanometer mirror 65 in the directions that are perpendicular to the center axis. Therefore, when the galvanometer mirror 65 rotates, the deflection direction of the illumination light changes.

The first mirrors 66 are also rectangular mirrors. Four pieces of the first mirrors 66 are attached to the case of the illumination unit 60 within the range of the deflected illumination light due to the rotation of the galvanometer mirror 65. The orientations of the first mirrors 66 are adjusted so that the reflected lights by the first mirrors 66 are parallel with each other and arranged at equal intervals.

The second mirrors 67 are also rectangular mirrors. Four pieces of the second mirrors 67 are attached to the case of the illumination unit 60 so as to locate on the light paths of the illumination lights reflected by the first mirrors 66, respectively. The orientations of the second mirrors 67a are adjusted so that the reflected lights by the second mirrors 67 are parallel with each other and arranged at equal intervals.

The mirror position detector 68 detects a start timing when the galvanometer mirror 65 rotates to supply the illumination light to the respective first mirrors 66. The mirror position detector 68 is attached to the case of the illumination unit 60 at the position that does not interfere with the optical paths of the illumination light towards the first mirrors, but is included within the range of the deflected illumination light due to the rotation of the galvanometer mirror 65.

The illumination unit 60 constituted as described above is supported by a tip of an arm (not shown) in the same manner as the first embodiment. When a user sets up four pieces of the illumination units 60 around the operating section, a user must adjust each unit so that the light reflected from the second mirror 67 that is the farthest from the operating section (the second mirror 67 at the bottom position in FIG. 7) illuminates the above-mentioned first focus position in the direction perpendicular to the optical axis of the imaging optical system 11, and so that the light reflected from the second mirror 67 that is the closest to the operating section (the second mirror 67 at the top position in FIG. 7) illuminates the above-mentioned fourth focus position in the direction perpendicular to the optical axis of the imaging optical system 11.

The rotating condition of the galvanometer mirror 65 in each of the four illumination units 60 is controlled by an illumination controlling device (not shown). The illumination controlling device supplies electric power to a motor (not shown) that drives the galvanometer mirror 65. The illumination controlling device also receives the signal from the mirror position detector 68 to adjust an amount of the electric power supplied to the motor, which enables a feedback control on the rotating speed of the galvanometer mirror 65. The illumination controlling device receives the switching signal equivalent to the vertical synchronizing signal from the synchronous controlling circuit 22 of the main unit 20 in FIG. 3 and controls the rotation timing of the galvanometer mirror 65 in synchronization with the timing of frame change in the image signal to direct the illumination light toward four pieces of the first mirrors 66 one by one in order. Therefore, the illumination light is incident on the first through fourth focus positions one by one in order by means of the illumination controlling device (not shown).

According to the three-dimensional imaging device 35. of the fourth embodiment, the parts in the first through fourth focus positions in the operating section are illuminated one by one in order. A shape of an illuminated part is a round slice. The camera unit 10 focuses on the illuminated part among the first through fourth focus positions and captures an image of the illuminated part. The image signals are acquired by repeating the sampling in the depth direction (i.e., the direction of the optical axis of the imaging optical system). The image signals are outputted as groups each of which includes four frames representing the first through fourth focus positions that are captured when the imaging optical system 11 focuses on the first through fourth focus positions, respectively. The depth synchronizing signal (ZSYNC) is superimposed on the G signal in each frame.

Therefore, the three-dimensional imaging system of the fourth embodiment can supply the image signal that can be processed by the above-mentioned three-dimensional display device.

### Fifth Embodiment

In the fourth embodiment, the configuration of the lens-barrel of the camera unit is different from that in the first embodiment. The lens frames 121, 122, and 123 in the first embodiment are fitted inside the lerns-barrel 12b so that the lens frames can slide in the optical axis direction. On the other hand, the lens frames 121′, 122′, and 123′ in the fifth embodiment are supported by the watt link mechanism in the lens-barrel 12b′ so that the lens frames can move in the optical axis direction.

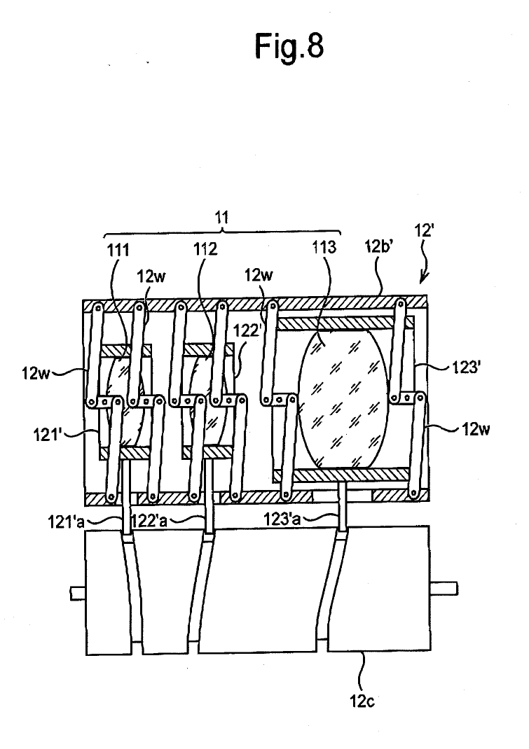

FIG. 8 shows a configuration of a driving mechanism 12′ for a camera unit 10 included in a three-dimensional imaging system concerning the fifth embodiment.

The first, second, and third lenses 111, 112, and 113 are also supported by the lens frames 121′, 122′, and 123′, respectively, in the fifth embodiment as well as the first embodiment. However, the lens frames 121′, 122′, and 123′ are mounted inside the lens-barrel 12b′ by the watt link mechanism 12w. The watt link mechanism 12w allows the lens frames 121′, 122′, and 123′ to move in the axial direction with keeping the coaxial condition.

Three slits parallel to the axial direction are formed on the lens-barrel 12b′ so as to align on a straight line. Pin-shaped cam followers 121a′, 122a′, and 123a′ extended from the first, second, and third lens frames 121′, 122′, and l23′ come through the slits, respectively. A tip portion of each of the cam followers 121a′, 122a′, and 123a′ juts out of the lens-barrel 12b′ through the slit and is inserted into each of cam grooves formed around the cylindrical grooved cam 12c.

Even when the lens frames 121′, 122′, and 123′ of the camera unit 10 are supported by the well-known watt link mechanism 12w as in the fifth embodiment, the rotation of the cylindrical grooved cam 12c moves the lens frames 121′, 122′, and 123′ in the axial direction in parallel as in the case of the lens frames 121, 122, and 123 sliding inside the lens-barrel 12b in the first embodiment. That is, when the cylindrical grooved cam 12c rotates, the cam followers 121a′, 122a′, and 123a′ move in parallel in the axial direction with movement of the intersections of the cam grooves and the slits, which smoothly moves the lens-frames 121′, 122′, and 123′ in the axial direction together with the corresponding cam followers 121a′, 122a′, and 123a′. Further, the configuration with the watt link mechanism 12w in the fifth embodiment has longer-life than the sliding mechanism in the first embodiment.

In addition, the fifth embodiment adopts the well-known watt link mechanism 12w to support the lens frames 121′, 122′, and 123′ so that they can move in parallel. However, the scope of the invention is not limited to this configuration. For example, a Chebychev link mechanism can be used to obtain the effects of smooth movement and long life.

The present disclosure relates to the subject matter contained in Japanese Latent Application No. 2006-009005,filed on Jan. 18, 2006, which is expressly incorporated herein by reference in its entirety.

What is claimed is:

1. A three-dimensional imaging device that repeats a process for outputting three-dimensional image signals for displaying first through N-th elemental images that constitute a three-dimensional image, said device comprising:
an imaging optical system that forms an image of a subject with a focusing function and a compensation function to keep image magnification constant;
an illuminating section that repeats an action to irradiate illumination light in several directions that cross in its optical axis direction in turn to illuminate first through N-th positions on said subject that are different in distance from said imaging optical system;
a driving section that repeats an action to drive said imaging optical system so as to focus on one of said first through N-th positions to which the illumination light is irradiated by the illuminating section in synchronism with the action of the illuminating section,
a capturing section that repeats an action to capture the subject image formed by said imaging optical system to generate image signals in synchronism with the action of said illuminating section;
a superimposition section that superimposes a depth synchronizing signal on the image signal generated by said capturing section, as a synchronizing signal to specify which of said first through N-th elemental images is represented by the image signal, and
an output section to output the superimposed image signal.

2. The three-dimensional imaging device according to claim 1, wherein said capturing section generates the image signal that contains several color components, and
wherein said superimposition section superimposes said depth synchronizing signal on an image signal about a predetermined color among the image signals generated by said capturing section.

3. The three-dimensional imaging device according to claim 1, wherein said driving section further comprising: a cam follower provided to a lens frame for supporting said each lens that can move in the axial direction in parallel among lenses that constitute said imaging optical system;
a slit formed on a lens-barrel that contains each lens frame so that said cam follower comes therethrough; and
a cylindrical grooved cam around which a cam groove is formed so that the tip of each cam follower is inserted therein, and that can rotate about a center shaft to be parallel to the axial direction.

4. The three-dimensional imaging device according to claim 3, wherein said each lens frame is fitted inside said lens-barrel so that said each lens frame can slide in the axial direction.

5. The three-dimensional imaging device according to claim 3, wherein said each lens frame is supported by a watt link mechanism so that said each lens frame can move in the axial direction in parallel with keeping the coaxial condition.

6. The three-dimensional imaging device according to claim 1, wherein said illuminating section further comprises:
first through N-th linear light sources that are arranged in the optical axis direction of said imaging optical system;
first through N-th collimating optical systems each of which converts a part of the illumination light irradiated in a direction perpendicular to the corresponding linear light source into a parallel beam to be directed to the position among said first through fourth positions corresponding to the linear light source; and
an illumination controlling section that lights said first through fourth linear light sources one by one in order.

7. The three-dimensional imaging device according to claim 1, wherein said illuminating section further comprises:
a linear light source that is twisted with respect to the optical axis of said imaging optical system;
a collimating optical system that converts a part of the illumination light irradiated in a direction perpendicular to the corresponding linear light source into a parallel beam;
a galvanometer mirror for deflecting the illumination light that is converted into the parallel beam by said collimating optical system; and
first through N-th mirrors that reflect the illumination light deflected by said galvanometer mirror so that the reflected lights are incident on said first through fourth positions, respectively, with keeping the reflected lights in parallel to each other.

8. A three-dimensional imaging device that repeats a process for outputting three-dimensional image signals for displaying first through N-th elemental images that constitute a three-dimensional image, said device comprising:
an imaging optical system-that forms an image of a subject with a focusing function and a compensation function to keep image magnification constant;
an illuminating section that repeats an action to irradiate illumination light in several directions that cross in its optical axis direction in turn to illuminate first through N-th positions on said subject that are different in distance from said imaging optical system;
a driving section that repeats an action to drive said imaging optical system so as to focus on one of said first through N-th positions to which the illumination light is irradiated by the illuminating section in synchronism with the action of the illuminating section;
a capturing section that repeats an action to capture the subject image formed by said imaging optical system to generate image signals in synchronism with the action of said illuminating section; and
an output section to output the image signal.
